(19) United States
(12) Patent Application Publication
(10) Pub. No.: US 2008/0018017 A1
(43) Pub. Date: Jan. 24, 2008

(54) MODIFIED TRANSITION ANGLE IN BELLED PIPE

(76) Inventors: Guido Quesada, San Jose (CR); Shahriar Rahman, Fort Worth, TX (US)

Correspondence Address: Charles D. Gunter, Jr.;Whitaker, Chalk, Swindle & Sawyer, LLP, 301 Commerce Street, Suite 3500, Fort Worth, TX, 76102-4186, US

(21) Appl. No.: 11/780,868

(22) Filed: Jul. 20, 2007

Related U.S. Application Data
(60) Provisional application No. 60/832,638, filed on Jul. 21, 2006.

(51) Int. Cl. B29C 57/02

(52) U.S. Cl. 264/249; 285/21.2

(57) ABSTRACT

A method is shown for joining and sealing a female plastic pipe end having a belled end opening to a mating male plastic pipe end having an interior surface and an exterior surface. A sealing element is installed within a groove formed in the belled end of the female pipe section. The male pipe end is then inserted into the end opening of the female pipe end so that the elastomeric sealing gasket makes sealing contact with the exterior surface of the male pipe. A modified transition angle controls the distance the male pipe travels longitudinally within the end opening of the female plastic pipe to prevent overinsertion of the male pipe within the female pipe opening. The modified transition angle thereby lowers the incidence of damage caused by overinsertion by reducing the stress concentration on the socket.

### CROSS REFERENCE TO RELATED APPLICATIONS

The present application claims priority from the earlier filed provisional application, Ser. No. 60/832,638 filed Jul. 21, 2006, entitled “Modified Transition Angle in Belled Pipe,” by the same inventors.

### BACKGROUND OF THE INVENTION

1. Field of the Invention

The present invention relates generally to the field of plastic pipe systems of the type used in the municipal water works industry and similar applications, and in particular, to methods and devices for modifying the transition angle in the belled pipe in order to prevent problems caused by overinsertion of the spigot pipe end within the mating belled pipe end in making a secure connection between two plastic pipes in a pipeline.

2. Description of the Prior Art

Pipes are commonly used for the conveyance of fluids under pressure, as in city water lines. They may also be used as free-flowing conduits running partly full, as in drains and sewers. Pipes for conveying water in appreciable quantities have been made of steel, cast iron, concrete, ductile iron, and most recently, plastic including the various polyolefins and PVC.

It is well known in the art to extrude plastic pipes in an elongated cylindrical configuration of a desired diameter and to then cut the extruded product into individual lengths of convenient size suitable for handling, shipping and installation. In order to complete installation, piping joints are necessary to connect the individual cut lengths. These pipe sections are often connected on-site after being delivered from the manufacture location, usually immediately before or during installation as a free-flowing conduit. Traditionally, piping joints consist of a sealing function and a separate, external restraint mechanism.

In a typical application, each length of pipe is enlarged or “belled” at one end. The end opening of the belled pipe is of a sufficient diameter to mate with the next adjacent pipe section by inserting the unenlarged or “spigot” male end of the next adjacent length of pipe within the belled end opening. The inside diameter of the belled end is formed sufficiently large to receive the mating spigot pipe end, while allowing sufficient clearance to permit the application of an elastomeric gasket or other sealing device. Gasket-joint PVC pipe joints are virtually leak-free, and are easily assembled when a plurality of pipe lengths are joined to form a pipeline, e.g. by using a push-together or deep insertion construction method.

One problem which has been identified with gasket joint PVC pipes is that of possible overinsertion of the male, spigot pipe end into the mating female, belled pipe end during assembly of the pipe sections into a pipeline installation. The possible problems which can result from overinsertion of the male pipe end into the female pipe end at a pipe joint have been recognized in the past. For example, see “Longitudinal Mechanics of Buried Thermoplastic Pipe: Analysis of PVC Pipes of Various Joint Types”, Rahman and Watkins, American Society of Civil Engineers Pipeline Conference 2005, Houston, Tex. Various pipeline failure analyses have been traced back to excessive stresses on the bell pipe end as a result of overinsertion of the male pipe end. This could occur, for example, where the installation contractor uses a backhoe to push several sections of plastic pipe together in forming a pipeline. Common practice is for the contractor to push up to five joints back on the pipe in forming a section of pipeline. Sections are marked visibly on the exterior to indicate the approximate depth of insertion that the pipes should meet in order to form a secure connection. However, problems arise in the event that there is an obstruction, for example a slight mis-alignment between two connecting pipes. This can cause large amounts of stress in the connection joint of pipes immediately behind this obstruction. In order to compensate for this stress, these pipes may further insert, leading to fractures or faulty connections in their joints.

In spite of the fact that possible overinsertion of PVC pipe is understood to be a contributing cause of failure in some pipeline installations, to Applicant's knowledge, no current technology exists to address this problem in the same way that various technologies exist to address the problem of, for example, providing restrained joints.

A need exists therefore, for a method and apparatus to prevent the inadvertent overinsertion of the male, plastic pipe end within the mating female pipe end in forming a plastic pipeline.

A need also exists for such a method and apparatus which can be simply and easily implemented without greatly increasing the cost of the pipeline installation.

### SUMMARY OF THE INVENTION

It is therefore an object of the present invention to provide a method and apparatus for preventing overinsertion of plastic pipe in forming sealed connections in pipeline installations which is simple in design and dependable in operation and which does not add greatly to the cost of the sealing and restraining systems presently employed in the relevant industries.

In the method and apparatus of the invention, a female plastic pipe end having a belled end is both joined and sealed with a mating male plastic pipe end having an interior surface and an exterior surface. A sealing element is provided in the form of an elastomeric sealing gasket, the gasket being installed within an internal groove formed in the belled end of the female pipe section. Next, the male pipe end is inserted into the belled end of the female pipe end so that the elastomeric sealing gasket makes sealing contact with the exterior surface of the male pipe. The present invention concerns the recognition that a special control mechanism is necessary to control the distance that the male pipe travels longitudinally within the belled end of the female plastic pipe to thereby prevent overinsertion of the male pipe within the female pipe opening. Overinsertion may create a stress condition resulting in joint failure or leakage and may interfere with the normal expansion and contraction of the pipe joint.

In the present invention, the female pipe bell end forms an internal socket with a socket bottom wall. An interface angle exists between the male pipe end exterior surface and the socket bottom wall. The interface angle is increased by a predetermined amount in order to provide the control mechanism for preventing overinsertion of the male pipe within the female pipe opening. As will be described in detail in the invention which follows, increasing the interface angle at the bottom of the bell, e.g. from 15° to 30°, significantly lowers stress concentration and thereby reduces the incidence of damage caused by possible overinsertion.

The above as well as additional objectives, features, and advantages of the present invention will become apparent in the following detailed written description.

### BRIEF DESCRIPTIONS OF THE DRAWINGS

FIG. 1 is an exploded partially sectionalized view of a pipe joint in a plastic pipeline showing the sealing ring located within the female pipe end and the mating male pipe end.

FIG. 2 is a schematic representation of the problem of overinsertion of the male plastic pipe end within the mating female pie end in a plastic pipe system.

FIG. 3 is a partial, cross-sectional view of a portion of a pipe joint showing how the problem of overinsertion occurs.

FIG. 4 is a graphical representation of the forces involved in making up a pipe joint showing the peak in the stress curve.

FIG. 5 is a simplified schematic of a pipe joint showing the relevant contact angles of the male and female pipe ends which can be modified to lessen the possibility of overinsertion.

FIG. 6 is a graphical analysis of the Von Mises stress levels in the spigot and the bell under 100 kN overinsertion force.

### DETAILED DESCRIPTION OF THE INVENTION

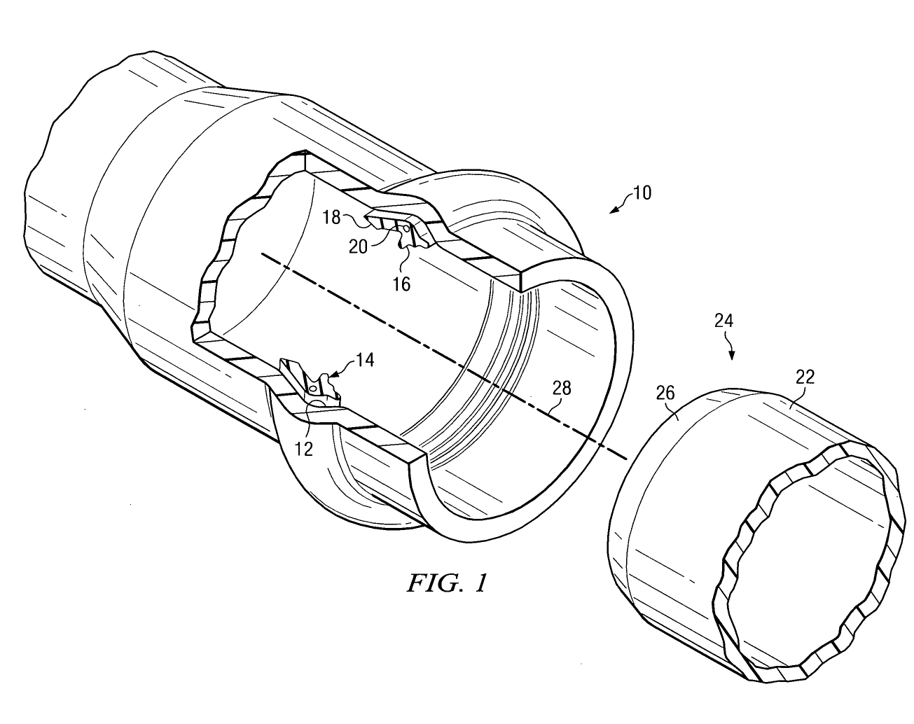

Turning to FIG. 1, there is shown an exploded view of a plastic pipe joint in which a belled female pipe end 10 is provided with an annular groove 12 for receiving an elastomeric sealing gasket 14. The annular sealing gasket 14 is a ring shaped member which, in cross section, has a compression seal region 16 and a trailing seal region 18. The gasket may be reinforced with a steel ring 20 which circumscribes the gasket body at one circumferential location. The sealing regions 16, 18 contact the exterior surface 22 of the mating male pipe section 24 upon assembly of the joint. During the assembly process, the male pipe end 24 travels to the left along the longitudinal axis 28 of the female, bell pipe end 10. Both of the pipe sections 10, 24 are formed of PVC. In the example illustrated in FIG. 1, the mating male pipe end 24 has a chamfered lip region 26. The sealing gasket is preferably made of a resilient elastomeric, thermoplastic material. For example, the sealing gasket may be formed of natural or synthetic rubber, such as SBR, or other elastomeric materials which will be familiar to those skilled in the plastic pipe arts such as EPDM or nitrile rubber. As will be apparent from the description which follows, any number of specialized sealing rings can be utilized in order to optimize the sealing function of the assembly.

The belled pipe end 10 may be formed by the so called “Rieber” process, familiar to those skilled in the waterworks industries. In the early 1970's, a new technology was developed by Rieber & Son of Bergen, Norway, referred to in the industry as the “Rieber Joint.” The Rieber system employed a combined mold element and sealing ring for sealing a joint between the socket end and spigot end of two cooperating pipes formed from thermoplastic materials. In the Rieber process, the elastomeric gasket was installed within a simultaneously formed internal groove in the socket end of the female pipe during the pipe belling process. The provision of a prestressed and anchored elastomeric gasket during the belling process at the pipe factory provided an improved socket end for a pipe joint with a sealing gasket which would not twist or flip or otherwise allow impurities to enter the sealing zones of the joint, thus increasing the reliability of the joint and decreasing the risk of leaks or possible failure due to abrasion. The Rieber process is described in the following issued United States patents, among others: U.S. Pat. Nos. 4,120,521; 4,061,459; 4,030,872; 3,965,715; 3,929,958; 3,387,992; 3,884,612; and 3,776,682.

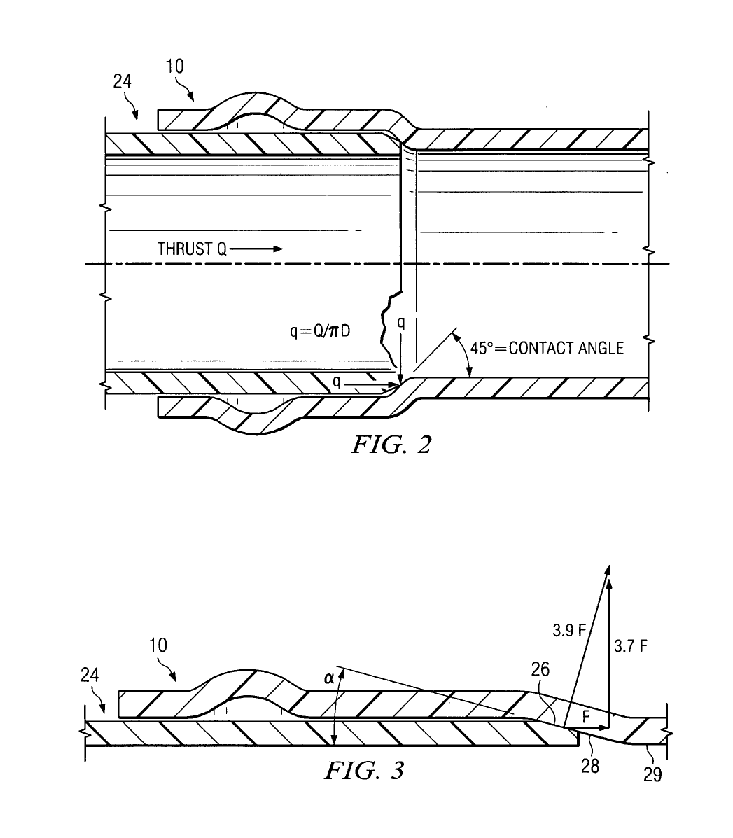

FIG. 2 of the drawings is a simplified illustration of the forces at work in a typical plastic pipeline installation which can lead to the problem of “overinsertion.” The PVC pipe joint shown in FIG. 2 is made up of a female, belled pipe section 10 and a male, spigot pipe end 24, as described with reference to FIG. 1. When the spigot is “stabbed” into the mating socket to make the connection, the pipes are assembled by a thrust force “Q.” At the present time in the industry, the male pipe has a “witness mark” on its exterior surface. This mark theoretically ensures that the backhoe operator will not overinsert the male pipe into the female, belled pipe end. However, any carelessness or inadvertence on the part of the backhoe operator may result in an excessive longitudinal thrust force “Q” being applied by the spigot against the female bell. If the connection is tight, internal pressure cannot reach the gasket. As a result, internal pressure fluctuations on the spigot cause undesirable concentrated stresses against the bell. Further, if the spigot is “jammed” into the throat of the bell during assembly of the joint, allowable joint deflection is reduced by approximately one half. With reference to FIG. 2, the longitudinal thrust “Q” imposes a radial force “q” on the 45° surface illustrated, which wedges the bell end outwardly and tends to shear the bell from the pipe, the radial force being:

q=Q/πD

where “D” is the bell diameter at that point.

FIG. 3 is another simplified illustration of the assembly forces encountered during the make up of a plastic pipe connection. When the beveled end 26 of the male, spigot pipe end reaches the bottom wall of the socket (generally at 28 in FIG. 3), the spigot acts upon the socket as a wedge. In FIG. 3, the bottom wall 28 forms an angle α of approximately 15° with respect to the internal diameter of the pipe wall 29. With a typical 15° angle between the taper of the male pipe and the bottom of the bell, the wedge effect is almost a factor of four. This means that, if a net force (after that which is taken out by seal friction) reaches the bottom of the socket pipe end, the resulting radial force which is attempting to force the socket open will be approximately four times greater, e.g., 3.9 and 3.7, respectively, in FIG. 3. This may be enough force to damage the bell pipe end and compromise the connection.

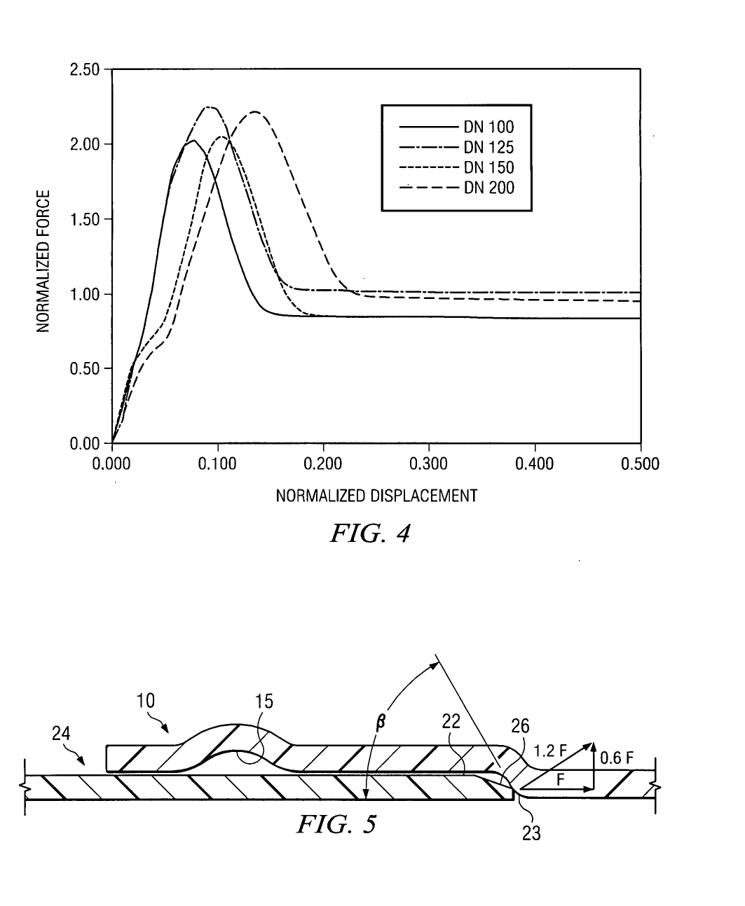

As briefly mentioned, current practice is to use a “witness mark” on the exterior surface of the male, spigot pipe end in order to lessen the possibility of overinsertion during joint make up. However, in practice, even if the male pipe is only installed up to the witness mark, overinsertion can occur on the joints immediately behind the first joint. This is due to the fact that there is a peak in the assembly force during make up, illustrated graphically in FIG. 4. As shown in FIG. 4, this peak is typically more than twice the final assembly force. When the joint reaches this peak, the force transmitted to the trailing pipes is greater than the resistance from the installed sealing gaskets. While a certain force is applied to overcome peak resistance from the sealing gasket, if the receiving pipe is not anchored, all of this force is transmitted to the joint behind. The seal in the joint behind is fully installed, so it will take out at most about 50% of this force by friction. The remainder of the force is the overinsertion force.

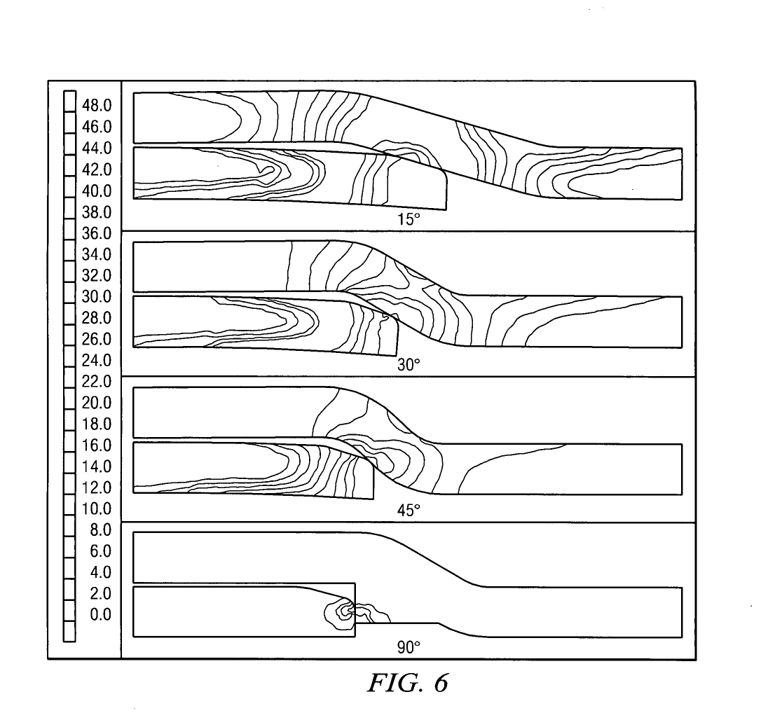

FIG. 5 is a schematic illustration of a typical belled pipe end 10 and mating male, spigot pipe end 24 illustrating a seal with a sustained assembly force. Theoretically, if the assembly force is sustained after it reaches the peak illustrated in FIG. 4, then the joints behind will offer at least the same resistance as the joint being assembled. This effect should reduce the incidence of overinsertion. In the present invention, the problem of overinsertion is addressed in FIG. 5 of the drawings by modifying the internal geometry of the belled end 10. FIG. 5 illustrates the approach to the problem in which the female pipe belled end 10 forms an internal socket with a socket bottom wall 23, and wherein an interface angle β exists between the nose of the male pipe end and the socket bottom wall 23, the interface angle being increased by a predetermined amount in order to provide the control mechanism for preventing overinsertion of the male pipe within the female pipe opening. This could be accomplished by modifying the belling mandrel so that it will render a sharp angle at the bottom surface of the socket, thereby reducing the wedge effect. For example, with reference to FIG. 5, if the interface angle β between the spigot and the bottom of the socket 23 is increased from 15° to 60° (i.e., the surface 23 forms a sharper angle), then the wedge effect would become about six times smaller.

FIG. 6 depicts the Von Mises stress of the spigot and the bell under 100 kN overinsertion force. The stress level on the spigot and the bell becomes lower as the interface angle (β in FIG. 5) is increased. In the present invention, the interface angle is preferably increased above 15°, more preferably in the range from about 20° to 40° and is most preferably about 30°. An increase to a 30° angle is feasible to reduce the incidence of damage caused by overinsertion. Overall stress on the socket is reduced by about 40% in the worst case condition, where there is initial overinsertion, a thermal expansion and no internal pressure. Further increases in the interface angle would not produce significant improvements due to contact stress concentration and it would become more difficult to manufacture in the belling process.

The present invention provides several advantages. The possible problem of overinsertion of the male, spigot pipe end within the female, bell pipe end is avoided by simple changes in the geometry of the bell end internal surfaces. The change in the angle at which the taper of the male pipe end contacts the bottom wall of the bell end opening can be adjusted to reduce the incidence of a “wedge effect” during joint make-up. The change in angle can be accomplished during the pipe belling generation at the pipe manufacturing plant by changes to the exterior of the pipe belling mandrel.

While the invention has been shown in one of its forms, it is not thus limited but is susceptible to various changes and modifications without departing from the spirit thereof.

I claim:

1. A method of joining and sealing a female plastic pipe section having a belled end with an end opening to a mating male plastic pipe end having an interior surface and an exterior surface, the method comprising the steps of:
providing a sealing element in the form of an elastomeric sealing gasket, the gasket being installed within a groove formed in the belled end of the female pipe section;
inserting the male pipe end into the end opening of the female pipe section so that the elastomeric sealing gasket makes sealing contact with the exterior surface of the male pipe; and
providing a control mechanism for controlling the distance the male pipe travels longitudinally within the end opening of the female plastic pipe to thereby prevent overinsertion of the male pipe within the female pipe opening.

2. The method of claim 1, wherein the female pipe bell end forms an internal socket with a socket bottom wall, and wherein an interface angle exists between the male pipe end and the socket bottom wall, the interface angle being increased by a predetermined amount in order to provide the control mechanism for preventing overinsertion of the male pipe within the female pipe opening.

3. The method of claim 2, wherein the interface angle exceeds about 15°, reducing the overall stress of the socket and minimizing the damage caused by overinsertion.

4. The method of claim 2, wherein the interface angle is in the range from about 20° to 40°.

5. The method of claim 2, wherein the interface angle is approximately 30°.

6. The method of claim 3, wherein the interface angle is formed concurrently when the belled end of the female pipe is formed.

7. A plastic pipe connection designed to prevent overinsertion of a male plastic pipe within a mating female plastic pipe in forming sealed connections in pipeline installations, comprising:
a female plastic pipe end having a belled end with an end opening;
a mating male plastic pipe end having an interior surface and exterior surface;
a sealing element in the form of an elastomeric sealing gasket installed within a groove formed in the belled end of the female pipe section; and
a control mechanism for controlling the distance the male pipe travels longitudinally within the end opening of the female plastic pipe to thereby prevent overinsertion of the male pipe within the female pipe opening.

8. The plastic pipe connection of claim 7, wherein the female pipe bell end forms an internal socket with a socket bottom wall, and wherein an interface angle exists between the male pipe end and the socket bottom wall, the interface angle being increased by a predetermined amount in order to provide the control mechanism for preventing overinsertion of the male pipe within the female pipe opening.

9. The plastic pipe connection of claim 8, wherein the interface angle exceeds about 15° in order to reduce the overall stress of the socket and minimize the damage caused by overinsertion.

10. The plastic pipe connection of claim 9, wherein the interface angle is in the range from about 20° to 40°.

11. The plastic pipe connection of claim 9, wherein the interface angle is approximately 30°.
